(19) United States
(12) Patent Application Publication
(10) Pub. No.: US 2017/0039484 A1
(43) Pub. Date: Feb. 9, 2017

(54) GENERATING NEGATIVE CLASSIFIER DATA BASED ON POSITIVE CLASSIFIER DATA

(71) Applicant: Hewlett-Packard Development Company, L.P., Houston, TX (US)

(72) Inventors: Brandon Niemczyk, Austin, TX (US); Josiah Hagen, Austin, TX (US)

(21) Appl. No.: 14/821,433

(22) Filed: Aug. 7, 2015

(51) Int. Cl. G06N 99/00; G06N 7/00

(52) U.S. Cl. CPC G06N 99/005; G06N 7/005

(57) ABSTRACT

Examples relate to generating negative classifier data based on positive classifier data. In one example, a computing device may: obtain positive classifier data for a first class, the positive classifier data including at least one correlated feature set and, for each correlated feature set, a measure of likelihood that data matching the correlated feature set belongs to the first class; determine, for each feature included in the at least one correlated feature set, a de-correlated measure of likelihood that data including the feature belongs to the first class; and generate, based on each de-correlated measure of likelihood, negative classifier data for classifying data as belonging to a second class.

### BACKGROUND

Machine learning methods are widely used to identify and match patterns in a variety of data types. Classification methods, for example, seek to identify to which category or categories a piece of data, or observation, belongs. Classification models are typically trained using a set of training data with known outcomes.

### BRIEF DESCRIPTION OF THE DRAWINGS

The following detailed description references the drawings, wherein:

FIG. 1 is a block diagram of an example computing device for generating negative classifier data based on positive classifier data.

FIG. 2 is an example data flow of a process for generating negative classifier data based on positive classifier data.

FIG. 3 is a flowchart of an example method for generating negative classifier data based on positive classifier data.

### DETAILED DESCRIPTION

Machine learning classifiers often use positive and negative examples in order to learn a classification function or functions. Positive examples may be included in positive classifier data, which may include, for example, data that has been positively identified as belonging to a particular class. In some situations, negative examples may be included in negative classifier data, which may include, for example, data that has been positively identified as not being of the particular class. In some situations, such as those where negative examples are missing or rare, it may be difficult to determine what a representative negative class would be. By de-correlating positive classifier data, a distribution of negative classifier data may be generated and used, in conjunction with the positive classifier data, e.g., to train a classifier.

By way of example, a decision tree is one type of classifier which may be used to classify data by looking at correlations of data with a data set or sets. E.g., in a situation where, for a class A, feature 2 always co-occurs with feature 1, there is a correlation of feature 2 co-occurring with feature 1. In situations where data representing a class that is not class A is lacking, or the potential data representative of the complement of class A is large, negative classifier data may be generated from the positive classifier data.

To generate negative classifier data, the positive class data is de-correlated. In the above example, the correlation supports a preference for feature 1 co-occurring with feature 2, but not feature 2 co-occurring with feature 1. De-correlating the positive data results in a negative class having an equal likelihood of being represented by both feature 1 co-occurring with feature 2 and feature 2 co-occurring with feature 1. The distribution of de-correlated data may be used to create negative classifier data. In a situation, for example, where class A has features [1, 2]50% of the time, [1, 3] 20% of the time, and no other occurrences of 1, 2, or 3, de-correlation of the features would result in the following feature probabilities: feature 1=35%, feature 2=25%, and feature 3=10%. Using the foregoing distribution, any number of negative training data examples may be generated, e.g., using a random number generator. Further details regarding the de-correlation of positive classifier data to generate negative classifier data is described in further detail in the paragraphs that follow.

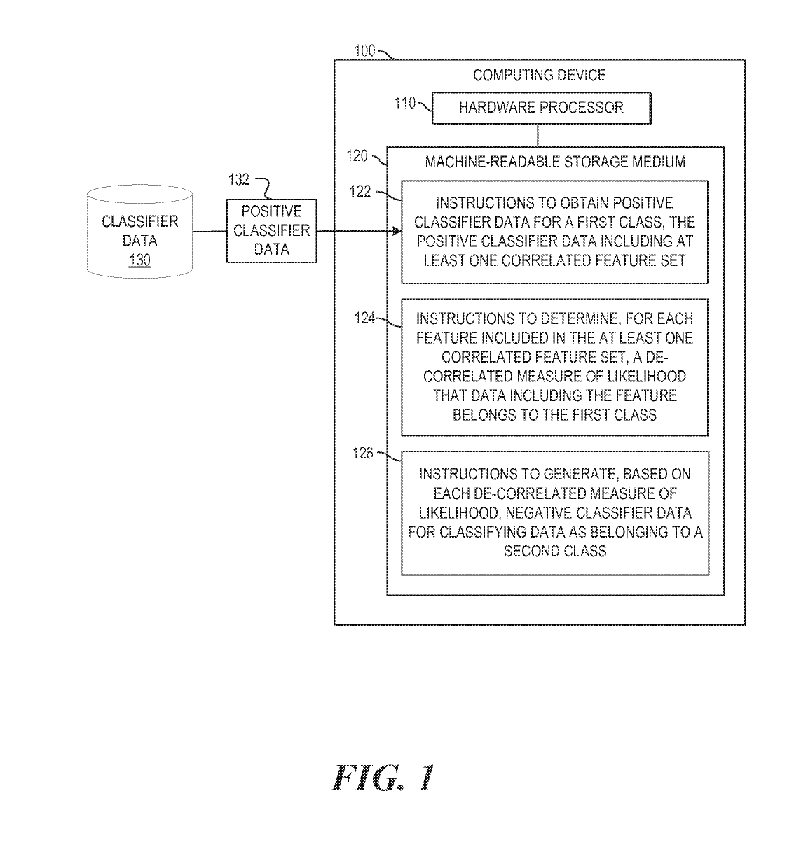

Referring now to the drawings, FIG. 1 is a block diagram of an example computing device 100 for generating negative classifier data based on positive classifier data. Computing device 100 may be, for example, a server computer, a personal computer, a mobile computing device, or any other electronic device suitable for processing data. In the embodiment of FIG. 1, computing device 100 includes hardware processor 110 and machine-readable storage medium 120.

Hardware processor 110 may be one or more central processing units (CPUs), semiconductor-based microprocessors, and/or other hardware devices suitable for retrieval and execution of instructions stored in machine-readable storage medium 120. Hardware processor 110 may fetch, decode, and execute instructions, such as 122-126, to control the process for generating negative classifier data based on positive classifier data. As an alternative or in addition to retrieving and executing instructions, hardware processor 110 may include one or more electronic circuits that include electronic components for performing the functionality of one or more of instructions.

A machine-readable storage medium, such as 120, may be any electronic, magnetic, optical, or other physical storage device that contains or stores executable instructions. Thus, machine-readable storage medium 120 may be, for example, Random Access Memory (RAM), an Electrically Erasable Programmable Read-Only Memory (EEPROM), a storage device, an optical disc, and the like. In some implementations, storage medium 120 may be a non-transitory storage medium, where the term “non-transitory” does not encompass transitory propagating signals. As described in detail below, machine-readable storage medium 120 may be encoded with a series of executable instructions: 122-126, for generating negative classifier data based on positive classifier data.

A classifier data storage device 130 is in communication with the computing device 100 to provide the computing device 100 with classifier data, e.g., positive classifier data 132. The classifier data storage device 130 may be included in a computing device, such as one similar to the computing device 100, and may include any number of storage mediums, similar to machine-readable storage medium 120. While the implementation depicted in FIG. 1 shows the classifier data storage device 130 as separate from the computing device 100, in some implementations, the positive classifier data 132 may be stored at the computing device 130, e.g., on the machine-readable storage medium 120

The computing device 100 executes instructions (122) to obtain positive classifier data 132 for a first class, the positive classifier data 132 including at least one correlated feature set. The positive classifier data 132 may also include, for each correlated feature set, a measure of likelihood that data matching the correlated feature set belongs to the first class. In some implementations, a separate computing device calculates the measures of likelihood for the positive classifier data, e.g., prior to storing them in the classifier data storage device 130. In some implementations, the computing device 100 may generate the positive classifier data 132 from positive example data.

By way of example, a network administrator may seek to identify streams of network traffic coming from a particular application. By analyzing network traffic known to be sent by the particular application, positive classifier data may be identified. One or more correlations may be observed between features of data streams that come from the application. E.g., 60% of data streams coming from the application may include a network packet of a particular size followed by a network packet of a particular protocol, which is followed by a network packet including a particular string of characters; and 30% of data streams coming from the application may include a network packet of the particular size followed by a network packet including the particular string, which is followed by a network packet with a particular header length. Using numbers to represent the each unique feature described above, positive classifier data for the foregoing example correlations may be, for example, a first ordered set: [1, 2, 3] (representing the packet size feature, packet protocol feature, and packet string feature), and a second ordered set: [1, 3, 4](representing the packet size feature, packet string feature, and packet header feature). For the purpose of this example, assume that no other occurrences of features 1, 2, 3, or 4 exist in the positive classifier data. An example of the positive classifier data is shown in Table 1, below.

TABLE 1
[1, 2, 3]
[1, 3, 4]
[5, 6, 7]
[1, 2, 3]
[1, 2, 3]
[1, 3, 4]
[1, 2, 3]
[1, 2, 3]
[1, 3, 4]
[1, 2, 3]

As shown in Table 1, 60% (6 of 10) of the example correlated features sets are [1, 2, 3] and 30% (3 of 10) are [1, 3, 4].

The computing device 100 executes instructions (124) to determine, for each feature included in the at least one correlated feature set, a de-correlated measure of likelihood that data including the feature belongs to the first class. In some implementations, each de-correlated measure of likelihood is determined by calculating a sum of each likelihood that the feature would be randomly selected from each of its corresponding feature sets. In the example above, features matching the correlated feature set [1, 2, 3] are included in 60% of network packet streams that are classified as coming from the particular application. A corresponding de-correlated feature set would allow for any ordered combination of the features 1, 2, and 3. Allowing for any order of the foregoing features, a random selection of feature 1 from the de-correlated set would occur approximately 1 in 3 times, resulting in a de-correlated measure of likelihood that feature 1 occurs in a network packet stream of 20% (0.6/3), for that feature set. For the second feature set, the de-correlated measure of likelihood that feature 1 occurs in a network packet stream is 10% (0.3/3), for that feature set. The sum of each likelihood is 30% (20%+10%), indicating that, ignoring the correlation, feature 1 would occur in network packet streams included in the positive classifier data approximately 30% of the time. Using the example above, de-correlation would result in feature 2 occurring approximately 20% of the time in network data streams, feature 3 occurring approximately 30% of the time network data streams, and feature 4 occurring approximately 10% of the time of network data streams.

The computing device 100 executes instructions (126) to generate, based on each de-correlated measure of likelihood, negative classifier data for classifying data as belonging to a second class. Negative classifier data may be generated, for example, by using a random number generated and the de-correlated measures of likelihood. Using the example measures of likelihood above, negative classifier data may be generated, e.g., as shown in Table 2, below.

TABLE 2
[3, 2, 1]
[1, 2, 3]
[2, 1, 3]
[4, 3, 1]
[3, 1, 4]
[2, 3, 1]
[5, 6, 7]
[1, 4, 3]
[1, 3, 2]
[3, 1, 2]

As shown in Table 2, 30% of the feature values are 1's, 20% of the feature values are 2's, 30% of the feature values are 3's, and 10% of the feature values are 4's. While the distribution of feature values in Table 2 is the same as the distribution among the positive classifier data, as shown in Table 1 above, the de-classification results in a random, or pseudo-random, distribution of the feature values among the feature sets. E.g., every correlated feature set including features 1, 2, and 3, in the positive classifier data includes the features in that order, while features 1, 2, and 3, are randomly distributed in the de-correlated feature sets of the negative classifier data.

In some implementations, the computing device 100 trains a classifier based on the positive classifier data 132 and the negative classifier data. For example, the computing device 100 may use the positive and negative classifier data to train a decision tree for use in classifying network traffic as belonging to a first class of network traffic coming from the particular application or a second class of network traffic that is not coming from the particular application. Negative classifier data that is generated based on positive classifier data may also be used to train other types of machine learning models that may make use of both positive and negative training data, such as a regression model, support vector machine, neural network, random forests, and boosting, to name a few. A trained classifier may receive, as input, test data that includes at least one feature value and produces, as output, an output class for the test data. For example, the trained classifier may receive a feature set of [1, 2, 4], and the classifier may produce, as output, an indication which class, or classes, the feature set likely belongs. Further examples and details regarding the generation of negative classifier data based on positive classifier data are provided in the paragraphs that follow.

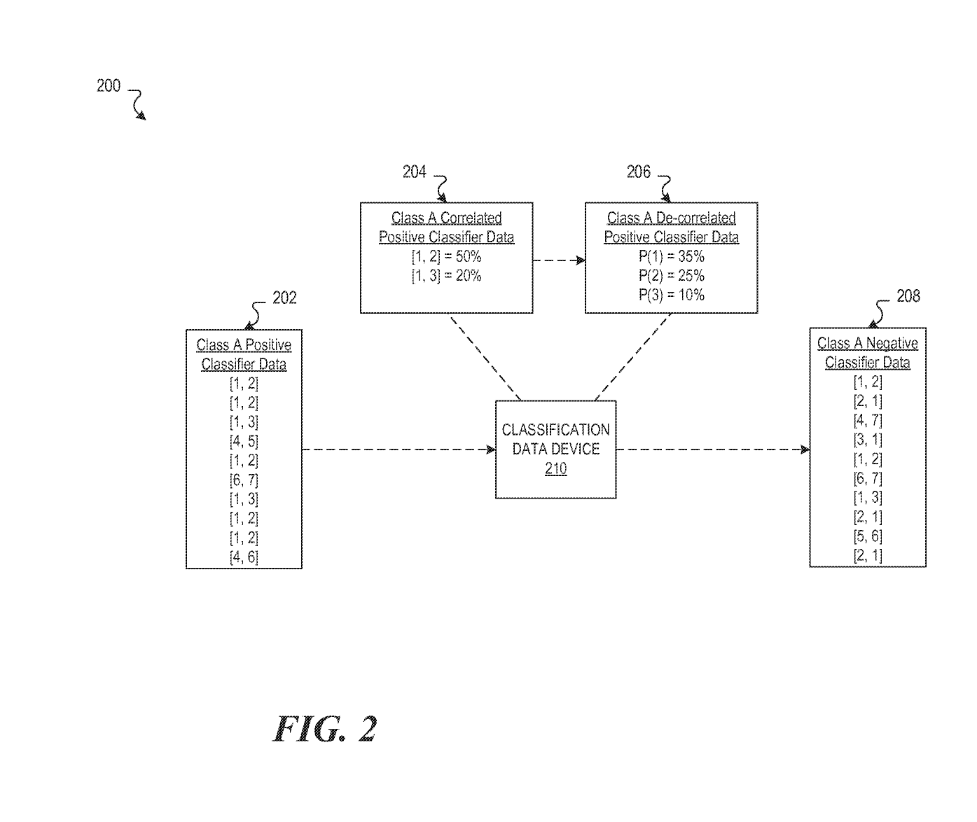

FIG. 2 is an example data flow 200 of a process for generating negative classifier data based on positive classifier data. The data flow 200 depicts a classification data device 210, which may be implemented by a computing device, such as the computing device 100 described above with respect to FIG. 1.

In the example data flow 200, the classification data device 210 receives positive classifier data 202 for a class, class A. The positive classifier data 202 may have been generated based on data known to correspond to class A. In this example, the positive classifier data 202 includes pairs of features. The classification device 210 identifies correlated data sets 204 for the positive classifier data 202. The correlated data sets 204 indicate that the ordered pair of features, [1, 2], has a correlation to Class A, e.g., 50% of Class A includes the ordered feature pair, [1, 2]. In addition, the correlated data sets 204 also indicate that the ordered pair of features, [1, 3] have a correlation to Class A, e.g., 20% of class A includes the ordered feature pair, [1, 3].

The classification data device 210 determines, for each feature included in the correlated classifier data 204, a de-correlated measure of likelihood that the data including the feature belongs to the first class. In the example data flow 200, the de-correlated data 206 specifies a probability, for each individual feature, that the feature would occur at any point in the positive classifier data 202. In this example, a total of 20 features are represented by the positive classifier data 202, and the de-correlated probabilities indicate that feature 1 occurs 7 times (p(1)=35%), feature 2 occurs 5 times (p(2)=25%), and feature 3 occurs two times (p(3)=10%).

Based on the de-correlated measures of likelihood 206, the classification data device 210 generates negative classifier data 208 for classifying data as belonging to a second class. In the example data flow, the second class may be the complement of the class A, e.g., the class of everything that is not class A. In some implementations, the classification data device 210 may use the de-correlated probabilities to create negative classifier data with the same feature distribution as the positive classifier data 202. The example negative classifier data 208 preserves the distribution of features, but without the correlations in the positive classifier data 202, e.g., the order of the features in the negative classifier data may be randomized.

As indicated in the examples above, the negative classifier data 208 and positive classifier data 202 may be used to train a machine learning model. The trained model may be used to determine whether a given input should be classified as either class A or not class A.

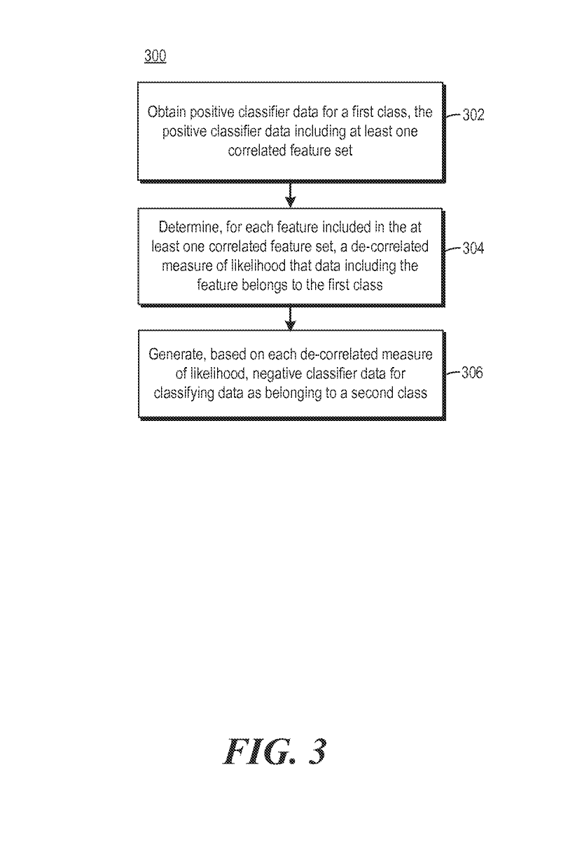

FIG. 3 is a flowchart of an example method 300 for generating negative classifier data based on positive classifier data. The method may be implemented by a computing device, such as computing device 100 described above with reference to FIG. 1. The method may also be implemented by the circuitry of a programmable hardware processor, such as a field-programmable gate array (FPGA) and/or an application-specific integrated circuit (ASIC). Combinations of one or more of the foregoing processors may also be used to generating negative classifier data based on positive classifier data.

Positive classifier data is obtained for a first class, the positive classifier data including at least one correlated feature set (302) and, for each feature set, a measure of likelihood that data matching the feature set belongs to the first class. For example, the correlated feature set may specify, for 40% of the first class includes a particular ordered set of features.

For each feature included in the at least one correlated feature set, a de-correlated measure of likelihood that data including the feature belongs to the first class is determined (304). The de-correlation may, for example, remove feature order from consideration in the de-correlated feature set. When feature sets are de-correlated, the de-correlated probability that any given feature exists in the positive classifier data is independent of the order in which that feature appears.

Based on each de-correlated measure of likelihood, negative classifier data is generated for classifying data as belonging to a second class (306). For example, after determining the probability that a particular feature will appear in the positive classifier data, without considering its correlation to another feature, the probability may be used to generate the negative classifier data used to classify data as not belonging to the first class, e.g., the second class may be the complement of the first class. As noted above, negative training data created in this manner may be used to train predictive models to classify data.

The foregoing disclosure describes a number of example implementations for generating negative classifier data based on positive classifier data. As detailed above, examples provide a mechanism for using de-correlated positive classification data to generate negative classifier data and potential applications of a system that is capable of generating negative classifier data from positive classifier data.

We claim:

1. A non-transitory machine-readable storage medium encoded with instructions executable by a hardware processor of a computing device for generating negative classifier data based on positive classifier data, the machine-readable storage medium comprising instructions to cause the hardware processor to:
obtain positive classifier data for a first class, the positive classifier data including at least one correlated feature set and, for each correlated feature set, a measure of likelihood that data matching the correlated feature set belongs to the first class;
determine, for each feature included in the at least one correlated feature set, a de-correlated measure of likelihood that data including the feature belongs to the first class; and
generate, based on each de-correlated measure of likelihood, negative classifier data for classifying data as belonging to a second class.

2. The storage medium of claim 1, wherein each de-correlated measure of likelihood is determined, for each feature included in the at least one correlated feature set, by calculating a sum of each likelihood that the feature would be randomly selected from each of its corresponding feature sets.

3. The storage medium of claim 1, wherein the instructions further cause the hardware processor to:
train a classifier based on the positive classifier data and the negative classifier data.

4. The storage medium of claim 3, wherein the classifier receives, as input, test data including at least one feature value and produces, as output, an output class for the test data.

5. The storage medium of claim 1, wherein each correlated feature set is correlated with respect to an order of feature values.

6. A computing device for generating negative classifier data based on positive classifier data, the computing device comprising:
a hardware processor; and
a data storage device storing instructions that, when executed by the hardware processor, cause the hardware processor to:
obtain positive classifier data for a first class, the positive classifier data including at least one correlated feature set and, for each feature set, a measure of likelihood that data matching the feature set belongs to the first class;
determine, for each feature included in the at least one correlated feature set, a de-correlated measure of likelihood that data including the feature belongs to the first class; and
generate, based on each de-correlated measure of likelihood, negative classifier data for classifying data as belonging to a second class.

7. The computing device of claim 6, wherein each de-correlated measure of likelihood is determined, for each feature included in the at least one correlated feature set, by calculating a sum of each likelihood that the feature would be randomly selected from each of its corresponding feature sets.

8. The computing device of claim 6, wherein the instructions further cause the hardware processor to:
train a classifier based on the positive classifier data and the negative classifier data.

9. The computing device of claim 8, wherein the classifier receives, as input, test data including at least one feature value and produces, as output, an output class for the test data.

10. The computing device of claim 6, wherein each correlated feature set is correlated with respect to an order of feature values.

11. A method for generating negative classifier data based on positive classifier data, implemented by a hardware processor, the method comprising:
obtaining positive classifier data for a first class, the positive classifier data including at least one correlated feature set and, for each feature set, a measure of likelihood that data matching the feature set belongs to the first class;
determining, for each feature included in the at least one correlated feature set, a de-correlated measure of likelihood that data including the feature belongs to the first class; and
generating, based on each de-correlated measure of likelihood, negative classifier data for classifying data as belonging to a second class.

12. The method of claim 11, wherein each de-correlated measure of likelihood is determined, for each feature included in the at least one correlated feature set, by calculating a sum of each likelihood that the feature would be randomly selected from each of its corresponding feature sets.

13. The method of claim 11, further comprising:
training a classifier based on the positive classifier data and the negative classifier data.

14. The method of claim 13, wherein the classifier receives, as input, test data including at least one feature value and produces, as output, an output class for the test data.

15. The method of claim 11, wherein each correlated feature set is correlated with respect to an order of feature values.
